(19) United States
(12) Patent Application Publication
(10) Pub. No.: US 2014/0285135 A1
(43) Pub. Date: Sep. 25, 2014

(54) SYSTEMS FOR HEATING A BATTERY AND PROCESSES THEREOF

(71) Applicant: EC POWER, LLC, State College, PA (US)

(72) Inventors: Yan JI, State College, PA (US); Chao-Yang WANG, State College, PA (US); Christian E. SHAFFER, State College, PA (US); Puneet K. SINHA, State College, PA (US)

(73) Assignee: EC POWER, LLC, State College, PA (US)

(21) Appl. No.: 14/189,843

(22) Filed: Feb. 25, 2014

Related U.S. Application Data
(60) Provisional application No. 61/804,334, filed on Mar. 22, 2013.

(51) Int. Cl. B60L 11/18; H02J 7/00

(52) U.S. Cl. CPC B60L 11/1875; H02J 7/0052; H02J 7/0054
USPC 320/103; 320/129

(57) ABSTRACT

A battery system is disclosed that can internally heat a battery by consuming minimal battery energy and with short heating times.

### CROSS-REFERENCE TO RELATED APPLICATION

This application claims the benefit of U.S. Provisional Application No. 61/804,334 filed Mar. 22, 2013 the entire disclosure of which is hereby incorporated by reference herein.

### TECHNICAL FIELD

The present invention relates generally to rechargeable electrochemical energy storage devices and processes for internally heating such devices from below an optimum temperature to a higher temperature. In particularly, the present disclosure is directed to rechargeable batteries that have efficient internal heating components and processes for internally heating such batteries.

### BACKGROUND

Electric drive vehicles are a promising technology for reducing both greenhouse gas emissions and dependence on foreign oil. The market share for plug-in hybrid electric vehicles (PHEV) and pure electric vehicles (EVs) has increased significantly in recent years. Despite offering the advantages of energy efficiency and low environmental impact, market penetration of EVs has been limited because of their relatively short driving range. Compared to gasoline vehicles with over 300 mile range before refueling, current generation EVs can achieve only 100 to 200 miles before recharging. Furthermore, the driving range from EVs is greatly reduced in cold environments. For instance, the driving range of the 2012 Nissan Leaf approaches 138 miles at the room temperature condition, but drops substantially to 63 miles in cold weather at temperatures of −10° C. [1].

At subzero temperatures, the driving range of EV is further adversely affected due to the poor performance of the battery and due to the additional burden of the use of the battery to heat the cabin of the vehicle. The poor performance of Li-ion batteries in EVs, for example, is closely related to significantly reduced energy and power capabilities of such batteries [2, 3], as well as capacity fade due to lithium plating upon charging [4, 5].

Fundamentally, the poor performance of Li-ion batteries at subzero temperatures arises from sluggish kinetics of charge transfer [6, 7], low electrolyte conductivity [8, 9] and reduced solid-state Li diffusivity [6, 10]. While these limitations might be alleviated by finding more suitable electrolyte and active materials, an alternative approach is to devise a system to quickly pre-heating the battery to normal operation temperatures before use [11, 12]. Since the kinetic and transport processes are highly temperature dependent, cell performance will quickly recover during warm up.

The poor performance of Li-ion cells at subzero temperatures implies significantly increased internal resistance. A tenfold increase in resistance relative to room temperature has been measured from commercial cells at −20° C. [13]. While the high internal resistance reduces cell energy and power capability, it is beneficial to cell warm up because of more internal heat generation (=I²R where R is the internal resistance), which can induce remarkable temperature rise and thereby restore battery energy.

Some attempts to heat batteries in electric or hybrid electric vehicles have been disclosed. For example, U.S. Pat. No. 6,072,301 discloses a resonant self-heating battery electric circuit to heat a battery prior to use. The electrical circuit requires the use of storage circuit for storing energy. U.S. Pat. Nos. 6,441,588 and 8,334,675 relate to a battery charging method that includes pulse charging and discharging operations to heat a battery prior to charging the battery. The pulse charging and discharging operations are applied to the battery as a whole by a charger that is external to the battery. However, a continuing need exists to ameliorate the reduced performance of rechargeable batteries subjected to cold temperatures.

### SUMMARY OF THE DISCLOSURE

An advantage of the present invention is a battery system that can internally heat the battery of the system from below an optimum temperature, e.g., sub-operating temperature, to a higher temperature, e.g., about operating temperature, by using the heat generated through internal resistance of the battery itself. The battery system of the present disclosure can be included in an electric vehicle or plug-in hybrid electric vehicle and advantageously minimize battery energy consumption and extend the driving range of the vehicle in subfreezing environments.

These and other advantages are satisfied, at least in part, by a process of internally heating one or more batteries in a battery system. The process comprises: determining a first temperature of the battery or batteries; internally heating the one or more batteries by a pulse charging and discharging cycle between a first group of cells and a second group of cells within the battery or between two or more batteries if the first temperature is below a predetermined temperature (T1); and discontinuing the pulse charging and discharging cycle when the first temperature reaches a second predetermined temperature (T2).

Embodiments of the present disclosure include shuttling electrical energy between two or more groups of cells in a battery pack, wherein the pulse charging and discharging cycle is between a period of one tenth and a few tens seconds, wherein the one or more batteries are lithium ion batteries and a lower voltage level of power pulses is between about 0.5 and 3 V, and wherein the pulses can be constant current, constant voltage or constant or variable power. Additional embodiments include imposing a high frequency alternating current (AC) on a net non-zero mean DC current draw from a battery pack, and wherein the battery pack includes lithium ion batteries and a lower voltage level of AC pulses is between about 0.5 and 3V.

Another aspect of the present a battery system comprising a first cell group and a second cell group and an onboard controller for shuttling current between the first and second cell groups and sensing a first predetermined temperature and a second predetermined temperature of the first or second cell group.

Embodiments of the present disclosure include a DC-DC converter to shuttle DC pulse current between the two or more groups of cells; a switch in conjunction with the onboard controller for managing the amplitude and frequency of shuttling pulse current between the two or more group of cells; a voltage controlling device to maintain cell voltage at a pre-determined limit during shuttling pulse current between the two or more group of cells. Additional embodiments include a signal generating device to generate an AC signal with a pre-determined amplitude, frequency and wave form; a voltage controlling device to maintain cell voltage in a pre-determined limit during shuttling pulse current between the two or more group of cells.

Additional advantages of the present invention will become readily apparent to those skilled in this art from the following detailed description, wherein only the preferred embodiment of the invention is shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent similar elements throughout and wherein:

FIG. 1 is a schematic illustrating a mutual pulse heating of batteries or groups of batteries using a direct current (DC) source according to an embodiment of the present disclosure.

FIG. 2 is a schematic illustrating a mutual pulse heating of batteries or groups of batteries using an alternating current (AC) source according to an embodiment of the present disclosure.

FIG. 3 shows a series of charts comparing voltage and temperature evolution during mutual pulse heating. In the figure, FIG. 3(a) charts the entire heating process, FIG. 3(b1) charts the first 20 seconds (s) for cell 1, and FIG. 3(b2) charts the first 20s for cell 2.

FIG. 4 shows a chart of the heating efficiency of mutual pulse heating.

FIG. 5 shows a chart of the temperature evolution during AC heating at various frequencies.

### DETAILED DESCRIPTION OF THE DISCLOSURE

The present disclosure relates to a rechargeable battery system that employs the internal resistance of the cells of the battery to heat the battery. As used herein the term battery is used to represent any rechargeable electrochemical energy storage device. The battery system of the present disclosure can be applied to a variety of batteries such as, but not limited to, lithium-ion, lithium-polymer, nickel-metal hydride, and lead-acid batteries. Such batteries can be used to power automotive, electric bike, portable electronics, and large-scale energy storage applications including telecommunication power backups, renewable energy storage for photovoltaics and wind.

As noted in the background section, attempts were made to heat a battery [14, 15] but such attempts may be limited as they either require a battery to be connected to external power sources [14] or rely on an electronic circuit that has limited electricity storage capacity [15], thereby limiting applicability to heating a large battery pack in a limited space such as in vehicles. An advantage of the present disclosure is a battery system that employs a completely solid-state heating method, whereby electricity is shuttled back and forth between cells of a battery or between modules in a battery pack in order to efficiently heat the battery or batteries in the battery pack.

In practicing an embodiment of the present disclosure, a battery system comprises one or more batteries. The battery or batteries comprise at least a first group of cells and a second group of cells. As used herein a group of cells can include one cell or more than one cell as the group. Two or more groups of cells can be from within the same battery or between two or more batteries such as between two or more batteries in a battery pack. When the battery or batteries of the system is/are below a predetermined temperature (T1), e.g., below about 5° C. or less than about 0° C., a pulse charging and discharging cycle between the first cell group and the second cell group can be initiated to internally heat the battery or batteries. The pulse charging and discharging cycle can be continued until the battery or batteries in the system reach a second predetermined temperature (T2), e.g., above 0° C. or 5° C. In one aspect of the present disclosure, the battery is internally heated by the mutual pulse heating cycle and then the battery power is immediately used to operate an external load without the battery undergoing a charging cycle by an exterior power source such as power from a stationary power source.

The battery system of the present disclosure advantageously does not require an external power source or a storage device for heating the battery and therefore can be implemented in a variety of situations and systems. For instance, an electric vehicle left unplugged in an open parking space under cold temperatures cannot utilize the heating strategies effectively described in references 14, 15 and 16 whereas, as will be shown herein, the current disclosure allows effective battery pack heating in such scenarios.

The battery system of the present disclosure can significantly reduce heating time as compared with other systems, e.g. convective heating, direct discharge of the pack, while minimizing the amount of battery energy expended for heating the battery. The battery system of the present disclosure can advantageously heat a battery at below an optimum temperature, e.g., exposed to cold temperatures such as below about 0° C. or less. The system can rapidly heat the battery with minimal loss of useable battery capacity or energy. Further, the battery system of the present disclosure has substantial benefits such that it does not require additional moving parts, involvement of fluids or circulation loops, minimal additional weight/volume requirements, no additional storage circuit for storing energy, etc. to operate effectively. While these additional elements are not needed to internally heat the battery, they can be included in system.

In one aspect of the present disclosure, a battery system includes a first cell group and a second cell group. The system further comprises a controller for shuttling current between the first and second cell groups. The system can also include one or more temperature sensors to measure the temperature of the cells in the various groups and optionally an onboard device or connection to external AC power source for pulsing current between different group of cells or in the whole battery pack. The battery system of the present disclosure can be implemented in a variety of ways, and can use either energy stored in the cells of the battery pack themselves or external sources of energy, such as residential electricity or electricity generated by an internal combustion engine in a hybrid vehicle.

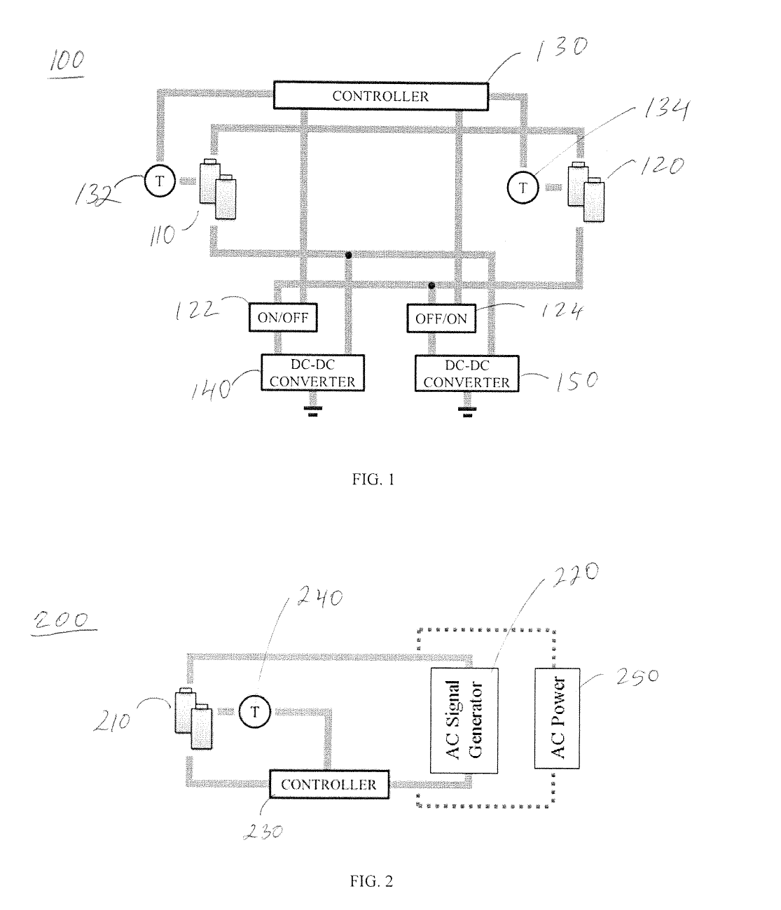

An embodiment of a battery system of the present disclosure is shown in FIG. 1. As shown in FIG. 1, battery system 100 includes a first group of cells 110 and a second group of cells 120. The designation of first group and second group is for convenience and does not signify preference or ordering of the cells. The system further includes switches 122 and 124, onboard controller 130 and temperature sensors 132 and 134. The switches and onboard controller can manage the amplitude and frequency of shuttling pulse current between the two or more groups of cells. In operation, whenever one cell group is discharging, the discharge energy is used to charge the corresponding cell group in the pack. In other words, the output power of a discharge group is used as the input power for a corresponding charge group. Since voltage required to charge cells is higher than cell output voltage, DC-DC converters 140 and 150 are used to boost the voltage of the discharge group of cells. The DC-DC converters can also shuttle DC pulse current between the two or more cell groups. Current pulse magnitude and frequency is controlled by the onboard controller having a circuit device. The system can also include a voltage controlling device to maintain cell voltage at a pre-determined limit during shuttling pulse current between the two or more cell groups.

To balance the capacity of the two groups, the charge/discharge roles of the two groups switch at intervals of a period. The optimum pulse charging and discharging cycle will vary with the type of battery or batteries in the system. In one embodiment, the pulse charging and discharging cycle is between about one tenth (0.1s) to about a few tens (e.g., three, four, five, ten, twenty, etc.) of seconds. By this process the two cell groups are mutually heated in a mutual pulse heating cycle. In operation, the mutual pulse heating cycle is employed when the battery of the system is below a first predetermined temperature (T1), i.e., below the operating or optimum temperature to operate the battery. The mutual pulse heating cycle is then discontinued when the battery reaches a second predetermined temperature (T2), i.e., near or at a normal operating temperature for the battery. The first predetermined temperature (T1) and second predetermined temperature (T2) can be monitored by temperature sensors 132 and/or 134. The first and second predetermined temperatures will vary depending on the battery and system but the optimum temperatures for any given battery can be readily determined using no more than routine skill in this art.

In one aspect of the present disclosure, the battery system includes one or more lithium ion batteries. A lower voltage level of power pulses is between about 0.5 and 3 V, depending on the battery application. Further, the pulses can be constant current, constant voltage or constant or variable power. The mutual pulse cycle can be carried out in a battery system of the present disclosure in an electric vehicle or plug-in hybrid electric vehicle. The process advantageously can minimizes battery energy consumption and extend the driving range in subfreezing environments of the vehicle, e.g. temperatures below 0° C. In addition, the pulse charging and discharging cycle is performed before fast charging in the subfreezing environments. By performing such a cycle, the interior of battery can be warm enough to avoid Li plating.

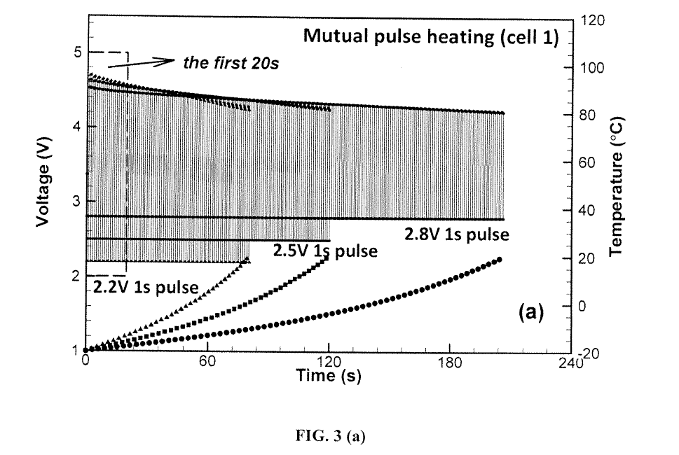

In another embodiment of the present disclosure, FIG. 2 illustrates battery system 200 which includes cells 210 within a battery pack and signal generating device 220 to generate a AC signal with a pre-determined amplitude, frequency and wave form and voltage controlling device 230 to maintain cell voltage in a pre-determined limit during shuttling pulse current between the two or more group of cells. The system can optionally have temperature sensor 240 and can optionally be connected to an external AC power source 250.

Signal generating device 220 can be an onboard device that takes a small DC current from cells 210 and generates an AC current signal at a predetermined frequency and amplitude. It allows superimposition of the generated AC current with the DC current generated by battery cells during operation. Controller 230 dynamically controls the amplitude and frequency of the AC signal to allow rapid cell heating without allowing cells to go beyond a pre-determined voltage limit.

Another option when using an AC signal for battery heating is the use of external AC power source 250 that can be used when the vehicle in plugged-in to an AC power source. Controller 230 under this circumstance has a circuit that dynamically determines the desired AC signal (amplitude and frequency) from the external AC power source.

In operation, the AC, which is generated internally or provided externally, is used to heat the cells (or a group of cells) within the battery pack. AC signals are described by two parameters: amplitude and frequency. To minimize the heating time, large amplitude signals are desired. However, caution should be exercised when using high power heating to avoid exceeding any maximum power limitation of the cell or battery system.

The signal frequency is an important parameter that affects effectiveness of battery heating while not the battery life. By passing AC current through the cells or groups of cells in a battery pack, the cell's impedance can be used to heat the cell internally via solid-state heating. As understood by those skilled in the art, by using different AC frequency, different portions of the applied current will be faradic current and double-layer current, respectively, which have certain consequences on battery heating speed and degradation rate.

In operation, the mutual pulse heating cycle is employed when the battery of the system is below a first predetermined temperature (T1), i.e., below the operating or optimum temperature to operate the battery. The mutual pulse heating cycle is then discontinued when the battery reaches a second predetermined temperature (T2), i.e., near or at a normal operating temperature for the battery. The first and second predetermined temperatures can be determined by temperature sensor 240 and will vary depending on the battery and system but the optimum temperatures for any given battery can be readily determined using no more than routine skill in this art.

In one aspect of the present disclosure, the battery system includes one or more lithium ion batteries and lower voltage level of AC pulses is between about 0.5 and 3V. Further, the AC pulse can be deployed with a zero mean DC current draw from the battery pack. The mutual pulse cycle can be carried out in a battery system of the present disclosure in an electric vehicle or plug-in hybrid electric vehicle. The process advantageously can minimize battery energy consumption and extend the driving range in subfreezing environments of the vehicle. In addition, the pulse charging and discharging cycle is performed before fast charging in the subfreezing environments so that the interior of the battery is warm enough to avoid Li plating.

### EXAMPLES

The following examples are intended to further illustrate certain preferred embodiments of the invention and are not limiting in nature. Those skilled in the art will recognize, or be able to ascertain, using no more than routine experimentation, numerous equivalents to the specific substances and procedures described herein.

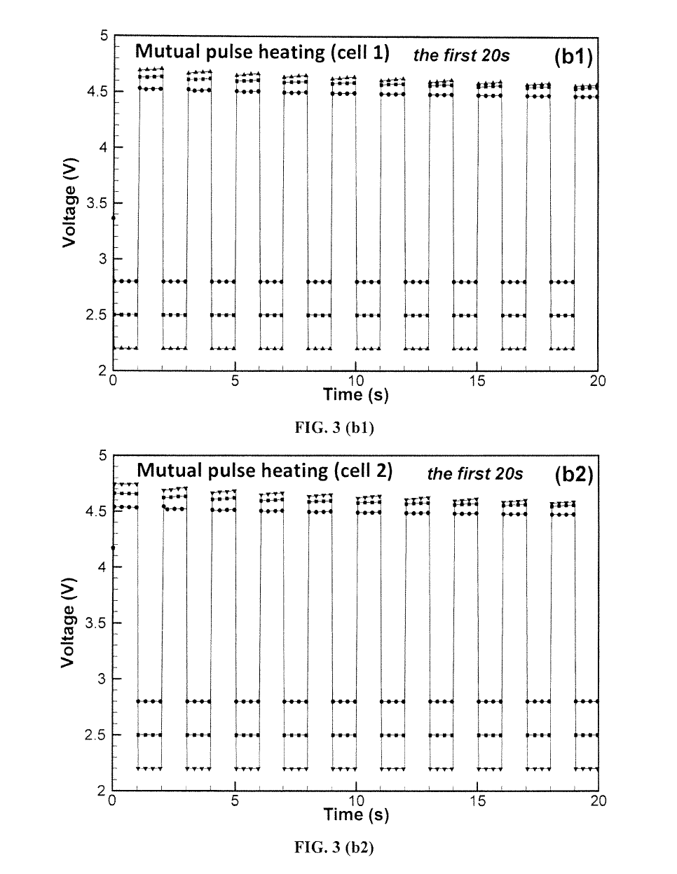

In the following example, a simulation is carried out for the mutual pulse heating cycle between two cells. For this simulation, two cells are connected using a dc-dc converter, as depicted in FIG. 1. The two cells start with the same initial conditions. The discharging cell is under a constant voltage mode. The voltage and temperature evolutions of cell 1 during the entire heating process are shown in FIG. 3(a). Discharge voltage levels of 2.2V, 2.5V and 2.8V are attempted independently. The lower levels of discharge voltage exhibit shorter heating time because of more heat generated internally. The pulse intervals are set to 1s. The voltage evolution profiles during the first 20s are magnified, as shown in FIG. 3(b1) for cell 1 and FIG. 3(b2) for cell 2. The lowest discharge voltage level (2.2V), however, yields the highest charging voltage, owing to much larger discharge current and thus higher output power.

The charging voltage may reach higher than 4.5V, giving rise to the possibility of Li plating. This problem can be alleviated by optimizing the pulse frequency, because higher frequency pulses generate smaller Li concentration buildup at the anode active material's surfaces. The mutual pulse heating cycle is tested for three different pulse intervals (0.1s, is and 10s). The starting cell voltage has been increased from 3.8V to 4.0V in order to evaluate the possibility of Li plating at high state-of-charge (SOC). Discharge voltage is kept at 2.5V. Modeling analysis found that 10s interval pulse shows extremely large variations in Li concentration at the anode active material's surface, rising and falling across most of the stoichiometry range. Moreover, it rises and approaches the saturation level during the first charging interval, implying high risk of Li plating. In contrast, the is and 0.1s interval pulses incur much smaller swings in Li concentration at the active material's surface and hence do not cause Li plating. Physically, high frequency pulse signal implies rapid switches between charge-discharge mode, preventing Li concentration buildup at the surface. Thus, one can optimize the mutual pulse heating cycle to reduce and/or eliminate battery degradation.

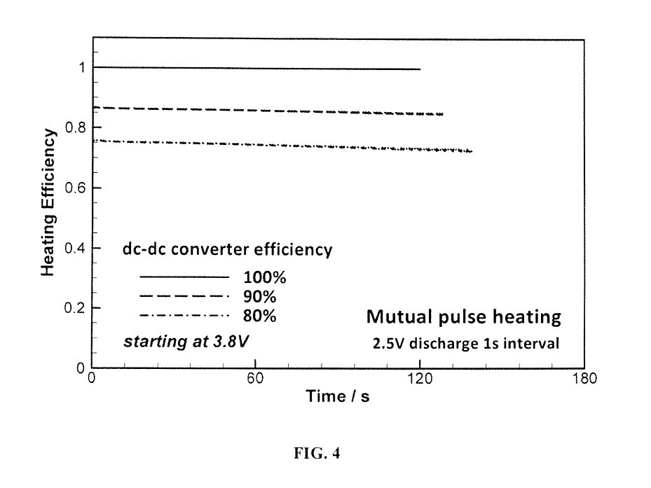

The mutual pulse heating cycle has several major advantages. First, it provides a heating system with low maintenance and high reliability due to lack of any moving parts, and without the need of circulating heat transfer fluid loop. Second, the batteries are internally heated, resulting in uniform and efficient warm up. Thirdly, high energy efficiency and short heating time can be realized because battery energy is consumed only to heat batteries from the inside out. No battery energy is wasted to heat surrounding fluids or solids outside the batteries. FIG. 4 shows the energy efficiency as a function of DC-DC converter efficiency. For realistic DC-DC converter efficiency of 90%, a heating efficiency of greater than 85% is realized. This means that over 85% of battery energy can be used to warm up thermal mass of battery cells. Finally, high frequency pulsing can be employed to reduce the risk of Li plating and hence battery degradation.

As another example of internally heating a battery prior to use to operate a load, a group of cells is connected to an AC power source, as shown in FIG. 2. A sinusoidal voltage signal of 5 mV magnitude is used as input to the group. We note that above a sufficiently high frequency, the current produced from faradic process (charge transfer at particle-electrolyte interface) is gradually bypassed by the current going through the double layer. That is, above a certain frequency the cell acts as a pure resistor, where both diffusional and kinetic processes are bypassed. This is an optimal regime for heating (like ohmic heating) without affecting battery life because there is neither electrochemical reaction nor the intercalation-deintercalation process taking place in the battery. Furthermore, the optimal frequency range decreases with reducing temperatures. For instance, the optimal frequency starts at 10 Hz at 25° C., 1 Hz at 0° C., and 0.1 Hz at −20° C. This means that the above-described benefits can be implemented at a relative lower AC frequency in cold weather condition. Based on our experimentation, household electricity can be a good option for internally heating a battery. The use of an AC power source has the advantage of combining easy accessibility and a frequency of 60 Hz which can be sufficient to internally heat a battery at low temperatures with low battery energy loss and detriment.

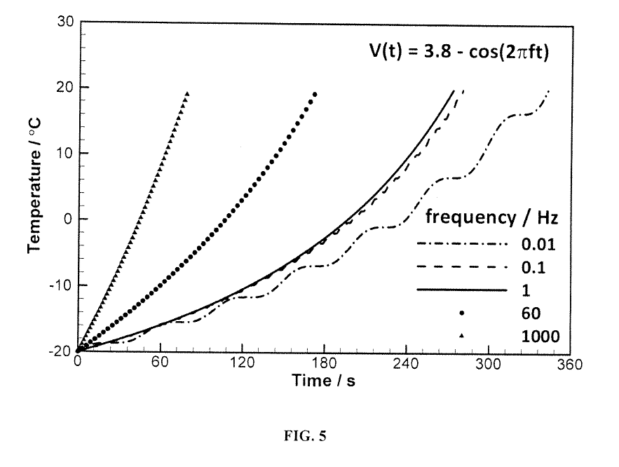

To test the mutual pulse heating cycle using an AC power source, a simulation voltage sinusoidal input is used as a protocol for Li-ion cells starting at −20° C. Signal frequency of 0.01 Hz, 0.1 Hz, 1 Hz, 60 Hz and 1000 Hz are tested respectively. The effect of AC frequency on heating time is shown in FIG. 5. With increasing signal frequencies, the heating time of batteries from −20° C. to room temperature (20° C.) decreases from 340s at 0.01 Hz, 170s at 60 Hz to 80s at 1000 Hz, indicating that significant amount of heating time can be saved by using high frequency signal. The frequency of 60 Hz was found to be sufficient for battery heating from subfreezing temperatures.

Overall, the mutual pulse heating cycle using an AC power source provides a fast way of heating a battery pack uniformly using external power. Household electricity can be used at its original frequency (60 Hz) and provides approximately 50% time saving compared to low frequency signals. In addition, the high frequency heating benefits cycle life because of reduced faradic current. Moreover, the mutual pulse heating cycle using an AC power source can be used in hybrid electric vehicles (HEVs), where the vehicle's onboard power can be extracted from the internal combustion engine and alternator to supply the AC power to run the mutual pulse heating cycle.

The battery systems and processes for heating a battery from cold temperatures according to the present disclosure are applicable to any system that has at least one rechargeable energy storage device for using in a variety of applications such as, but not limited to, vehicles, back up energy systems, grid energy storage.

Only the preferred embodiment of the present invention and examples of its versatility are shown and described in the present disclosure. It is to be understood that the present invention is capable of use in various other combinations and environments and is capable of changes or modifications within the scope of the inventive concept as expressed herein. Thus, for example, those skilled in the art will recognize, or be able to ascertain, using no more than routine experimentation, numerous equivalents to the specific substances, procedures and arrangements described herein. Such equivalents are considered to be within the scope of this invention, and are covered by the following claims.

References Cited:

[1] NissanUSA, How conditions affect range, http://www.nissanusa.com/leaf-electric-car/range?next=ev micro.section nav (2012).

[2] G. Nagasubramanian, J Appl Electrochem, 31 (2001) 99-104.

[3] S. S. Zhang, K. Xu, T. R. Jow, Electrochim Acta, 49 (2004) 1057-1061.

[4] H. P. Lin, D. Chua, M. Salomon, H. C. Shiao, M. Hendrickson, E. Plichta, S. Slane, Electrochem Solid St, 4 (2001) A71-A73.

[5] J. Fan, S. Tan, J Electrochem Soc, 153 (2006) A1081-A1092.

[6] C. K. Huang, J. S. Sakamoto, J. Wolfenstine, S. Surampudi, J Electrochem Soc, 147 (2000) 2893-2896.

[7] S. S. Zhang, K. Xu, T. R. Jow, J Power Sources, 115 (2003) 137-140.

[8] M. C. Smart, B. V. Ratnakumar, S. Surampudi, J Electrochem Soc, 146 (1999) 486-492.

[9] M. C. Smart, B. V. Ratnakumar, S. Surampudi, J Electrochem Soc, 149 (2002) A361-A370.

[10] S. S. Zhang, K. Xu, T. R. Jow, Electrochim Acta, 48 (2002) 241-246.

[11] M. D. Zolot, K. Kelly, M. Keyser, M. Mihalic, A. Pesaran, A. Hieronymus, Thermal Evaluation of The Honda Insight Battery Pack, in: 36th Intersociety Energy Conversion Engineering Conference, Savannah, Ga., 2001, pp. 923.

[12] A. Pesaran, A. Vlahinos, T. Stuart, Cooling and Preheating of Batteries in Hybrid Electric Vehicles, in: The 6th ASME-JSME Thermal Engineering Joint Conference, Hawaii Island, Hi., 2003.

[13] S. S. Zhang, K. Xu, T. R. Jow, J Power Sources, 160 (2006) 1403-1409.

[14] K. Yagi, T. Ishikura, United States patent, Pat. No. 6,441,588 B1, Aug. 27, (2002)

[15] C. N. Ashtiani, T. A. Stuart, United States patent, Pat. No. 6,072,301, Jun. 6 (2000)

[16] C. Y. Wang, O. J. Kwon, Y. Ishikawa, United States patent, Pat. No. 8,334,675, Dec. 18 (2012)

What is claimed is:

1. A process of heating one or more batteries in a battery system, the process comprising:
determining a first temperature of the battery or batteries;
internally heating the one or more batteries by a pulse charging and discharging cycle between a first group of cells and a second group of cells within the battery or between two or more batteries if the first temperature is below a predetermined temperature (T1); and
discontinuing the pulse charging and discharging cycle when the first temperature reaches a second predetermined temperature (T2).

2. The process of claim 1 wherein the one or more batteries in the system is a battery pack and heating the battery pack involves a pulse charging and discharging cycle between two or more groups of cells in the battery pack.

3. The process of claim 1 wherein the battery system comprises:
a DC-DC converter to shuttle DC pulse current between the two or more groups of cells;
a switch and onboard controller that manages the amplitude and frequency of shuttling pulse current between the two or more group of cells;
a voltage controlling device to maintain cell voltage at a pre-determined limit during shuttling pulse current between the two or more group of cells.

4. The process of claim 1 wherein the pulse charging and discharging cycle is between one tenth and a few tens seconds.

5. The process of claim 3 wherein the one or more batteries are lithium ion batteries and a lower voltage level of power pulse is between 0.5 and 3 V.

6. The process of claim 3 wherein the pulses can be constant current, constant voltage or constant or variable power.

7. The process of claim 1 that relies partially or completely on imposing a high frequency alternating current (AC) on a net non-zero root mean square DC current draw from the battery pack for the pulse charging and discharging cycle.

8. The process of claim 7 wherein the battery system comprises:
a signal generating device to generate a AC signal with a pre-determined amplitude, frequency and wave form;
a voltage controlling device to maintain cell voltage in a pre-determined limit during shuttling pulse current between the two or more groups of cells.

9. The process of claim 7 wherein the battery pack includes lithium ion batteries and a lower voltage level of AC pulses is between 0.5 and 3V.

10. The process of claim 8 with a zero mean DC current draw from a battery pack.

11. The process of claim 1 wherein the battery system is included in an electric vehicle or plug-in hybrid electric vehicle and the process minimizes battery energy consumption and extends the driving range in subfreezing environments of the vehicle.

12. The process of claim 1 wherein the pulse charging and discharging cycle is performed before fast charging in the subfreezing environment.

13. A battery system comprising a first cell group and a second cell group and an onboard controller for shuttling current between the first and second cell groups and sensing a first predetermined temperature and a second predetermined temperature of the first or second cell group.

14. The battery system of claim 13 further comprising:
a DC-DC converter to shuttle DC pulse current between the two or more groups of cells;
a switch in conjunction with the onboard controller for managing the amplitude and frequency of shuttling pulse current between the two or more groups of cells;
a voltage controlling device to maintain cell voltage at a pre-determined limit during shuttling pulse current between the two or more groups of cells.

15. The battery system of claim 13 further comprising:
a signal generating device to generate a AC signal with a pre-determined amplitude, frequency and wave form;
a voltage controlling device to maintain cell voltage in a pre-determined limit during shuttling pulse current between the two or more group of cells.

16. The battery system of claims 13 wherein the battery is a lithium ion battery.

17. The battery system of claim 16 included in an electric powered vehicle.
